(19) United States
(12) Patent Application Publication
(10) Pub. No.: US 2007/0122144 A1
(43) Pub. Date: May 31, 2007

(54) Camera including lens protection cap

(75) Inventor: Dong-hun Han, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/520,662

(22) Filed: Sep. 14, 2006

(30) Foreign Application Priority Data
Nov. 28, 2005 (KR) 2005-114050

(51) Int. Cl. G03B 17/00

(52) U.S. Cl. 396/448

(57) ABSTRACT

A camera including a lens protection cap is provided. The camera includes a case, a lens, a power switch, and the lens protection cap. The lens is located inside the case and exposed toward a front side. The power switch is provided on the outer surface of the case, for turning the power on/off, and the lens protection cap is provided to prevent damage of the lens by shielding the lens when the power is turned off. The power switch and the lens protection cap are directly connected with each other to allow the lens protection cap to expose/shield the lens when the power switch is on/off-operated.

### CROSS-REFERENCE TO RELATED APPLICATIONS

This application claims all benefits accruing under 35 U.S.C. §119 from Korean Patent Application No. 10-2005-0114050, filed on Nov. 28, 2005, in the Korean Intellectual Property Office, the disclosure of which is incorporated by reference herein.

### BACKGROUND OF THE INVENTION

1. Field of the Invention

The present invention relates to a camera, and more particularly, to a camera including a lens protection cap for preventing damage of a lens.

2. Related Art

A camera includes a lens for forming an image by condensing or diverging light. Cameras are classified into digital cameras and analog cameras. In digital cameras, light that passes through a lens is condensed to form an image on an image sensor, whereas in analog cameras, light that passes through a lens is condensed to form an image on a film. When there is a damage, such as a scratch is generated on the lens, light is not uniformly refracted. As a result, distortion may be generated on a photographed image. Therefore, a protection cap is provided to a camera to protect the lens from becoming damages.

Protection caps are generally classified into manual type protection caps in which users are required to manually put on lenses, and auto type protection caps in which lenses are automatically opened/closed in response to power on/off operations of cameras. The manual type protection caps have advantages of a simple structure and low manufacturing costs; however, there are also disadvantages in that the users must manually cap the lenses, and that the manual type protection caps can be lost. In contrast, the auto type protection caps are much more convenient to use, but require additional parts, such as a motor and a gear for driving the protection caps. As a result, the structure of the auto type protection caps can be complicated, and can take up valuable space inside the cameras. In addition, manufacturing cost can also be increased.

### SUMMARY OF THE INVENTION

Several aspects and example embodiments of the present invention provide a camera including a lens protection cap exposing/shielding a lens in cooperation with a power switch controlling power ON/OFF operation of the camera. Such a lens protection cap can also realize lens exposing/shielding operations, without requiring additional driving elements, such as a motor and a gear.

Additional aspects and/or advantages of the invention will be set forth in part in the description which follows and, in part, will be obvious from the description, or may be learned by practice of the invention.

In accordance with an embodiment of the present invention, there is provided a camera including: a case; a lens located inside the case and exposed toward a front side; a power switch provided on the outer surface of the case, for turning a power ON/OFF; and a lens protection cap for preventing damage of the lens by shielding the lens when power is turned OFF, wherein the power switch and the lens protection cap are directly connected with each other such that the lens protection cap exposes/shields the lens when the power switch is ON/OFF-operated.

According to an aspect of the present invention, the power switch may slide in a side direction on an outer surface of the case to turn the power on/off, and the lens protection cap may move to the side direction a distance the power switch slides, so as to expose the lens.

According to another aspect of the present invention, the power switch may include a sliding lever mounted in the case such that the sliding lever is pushed to the side direction by a user's finger, and a metal power joint attached on the inside of the sliding lever, and when the sliding lever is slid to one side, the metal power joint allows a power circuit of the camera to be connected so that a current flows through the power circuit to turn the power on, while removing the lens protection cap from the lens.

According to an aspect of the present invention, the sliding lever of the power switch and the lens protection cap may be connected with each other using a connector, and the sliding lever, the connector, and the lens protection cap are integrally formed.

According to an aspect of the present invention, the camera may further include a printing unit installed inside the case to print an image on a printing medium. The printing unit may include an ink ribbon containing dye that develops color on the printing medium, and a thermal print head (TPH) heating the ink ribbon to sublimate the dye contained in the ink ribbon, thereby allowing the ink to permeate into the printing medium. The case may include a paper-feeding slot for supplying a printing medium on which an image is to be printed to the inside of the case, and a discharge slot discharging a printing medium on which an image has been printed to the outside of the case.

In accordance with another embodiment of the present invention, a camera comprises: a rectangular parallelepiped case having a lens provided on a front side, a display panel provided on a back side, and a power switch provided on an upper surface of the case to turn power ON/OFF; a printing unit arranged inside the case to print an image captured by the lens on a printing medium fed, via a paper feeding slot located on the upper surface of the case; and a lens protection cap provided to cover the lens, wherein the power switch and the lens protection cap are connected, via a connector, such that, when the power switch is turned ON, the lens protection cap covers the lens, and when the power switch is turned OFF, the lens protection cap uncovers the lens.

According to an aspect of the present invention, the power switch is mounted on the upper surface of the case, and is slidable in a side direction to turn the power ON/OFF, and the lens protection cap moves in the same side direction so as to cover/uncover the lens. Such a power switch comprises a sliding lever mounted on the case, and a metal power joint attached on the inside of the sliding lever, such that, when the sliding lever is slid to one side, the metal power joint allows a power circuit of the camera to be connected so that a current flows through the power circuit to turn the power ON, while removing the lens protection cap from the lens.

According to another aspect of the present invention, the sliding lever, the connector, and the lens protection cap are integrally formed by a polymer resin. The printing unit comprises an ink ribbon containing dye that develops color on the printing medium, and a thermal print head for heating the ink ribbon to sublimate the dye contained in the ink ribbon, thereby allowing the dye to permeate into the printing medium. In addition, a paper-feeding slot is provided for feeding the printing medium on which an image captured by the lens is to be printed into the inside of the case, and, likewise, a discharge slot is provided for discharging the printing medium on which an image has been printed to the outside of the case.

In addition to the example embodiments and aspects as described above, further aspects and embodiments of the present invention will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a perspective view of a camera, shown from a front side, according to an example embodiment of the present invention;

FIG. 2 is an enlarged perspective view of a lens protection cap relative to a lens of the camera shown in FIG. 1;

FIG. 3 is a perspective view of a camera, shown from a rear side, according to an example embodiment of the present invention;

FIG. 4 is a schematic view of a printing unit provided inside the camera as shown in FIG. 1; and

FIGS. 5 and 6 are views explaining operations of a power switch and a lens protection cap shown in FIG. 1.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

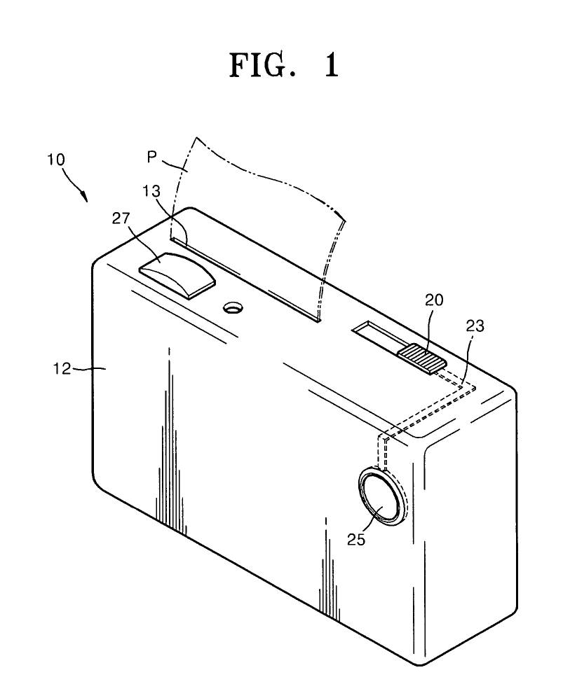

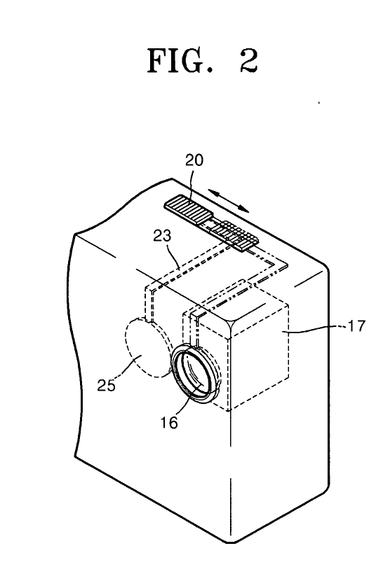

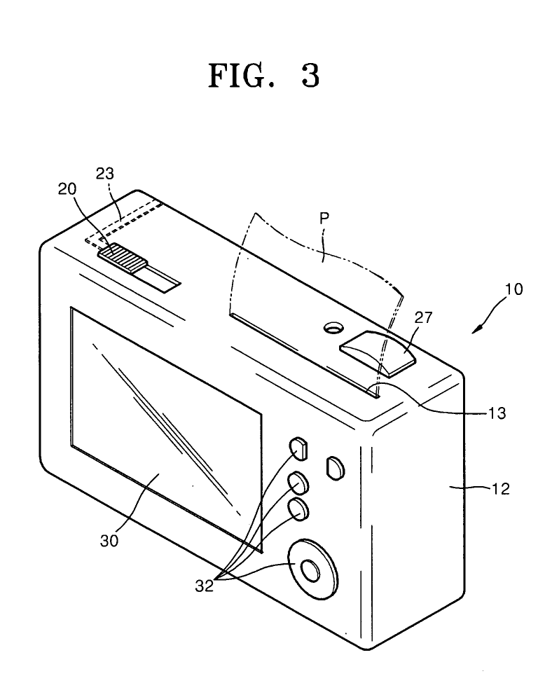

FIGS. 1 and 2 are a perspective view of a camera and an enlarged perspective view of a portion of the camera according to an example embodiment of the present invention, shown from a front side, respectively; and FIG. 3 is a perspective view of a camera according to an example embodiment of the present invention, shown from a rear side.

Referring to FIGS. 1 and 2, the camera 10 includes a rectangular parallelepiped case 12 and an image sensor 17 located inside the case 12 and on which light received from a front side is condensed to form an image. In addition, a lens 16 condensing or diverging light to form an image on the image sensor 17 is provided to the front side of the image sensor 17. The lens 16 is exposed to the front side of the camera 10, while power of the camera 10 is turned “on” and shielded by a lens protection cap 25, while the power of the camera 10 is turned “off” so that damage to the lens 16 such as scratches may be prevented.

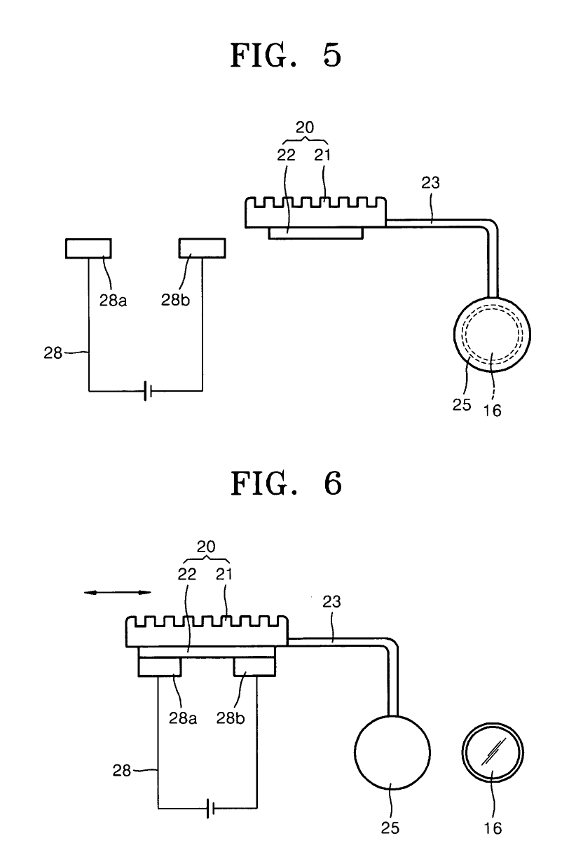

A power switch 20 is provided on the upper side surface of the case 12 to allow a user to turn the camera 10 on/off. The power switch 20 includes a sliding lever 21 (refer to FIGS. 5 and 6) mounted in the case 12 such that the sliding lever 21 may be easily pushed in a side direction by a user's finger, and a metal power joint 22 (refer to FIGS. 5 and 6) attached on the inside of the sliding lever 21. The sliding lever 21 and the lens protection cap 25 are connected with each other using a connector 23. The sliding lever 21, the connector 23, and the lens protection cap 25 are integrally formed of a polymer resin. This way the lens protection cap 25 can easily open and close a lens 16 when the power switch 20 is turned on/off, and there is no need to install driving elements, such as a motor and a gear, to drive the lens protection cap 25. In other words, the camera 10 does not need to separately include driving elements, such as a motor and a gear, to drive the lens protection cap 25. Instead, the camera 10 exposes/shields the lens 16 by moving the lens protection cap 25 in the same direction and the same distance as the power switch 20 slides when the power switch 20 slides.

Referring to FIG. 3, a display panel 30 for displaying an image and input buttons 32 for setting parameters of an image to be photographed, such as a data size of an image and a shooting mode are provided on the backside of the camera 10. A shooting button 27 is provided on the upper side surface of the case 12 for the user to shoot an image.

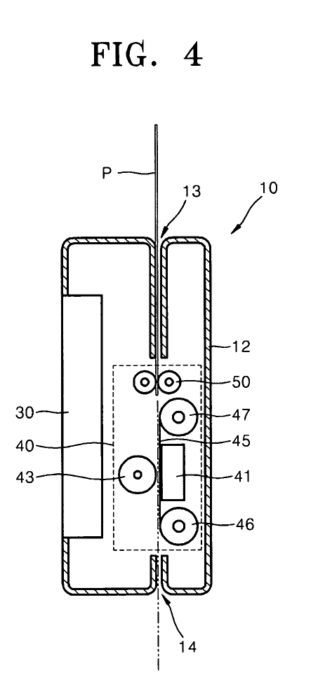

In addition, the camera 10 further includes a printing unit 40 (refer to FIG. 4) inside the case 12 to print an image on a printing medium P and output the same. A reference numeral 13 represents a paper-feeding slot for supplying a printing medium P to the printing unit 40 located inside the case 12. The paper-feeding slot 13 is formed in the upper side surface of the case 12. The printing unit 40 provided inside the camera 10, as shown in FIG. 1, will now be described in detail in connection with FIG. 4 herein below.

Referring to FIG. 4, the printing unit 40 includes a thermal print head (TPH) 41, a platent roller 43, an ink ribbon 45, ribbon support wheels 46 and 47, and a pair of delivery rollers 50. The ink ribbon 45 contains dye that develops color on the printing medium P. The thermal print head (TPH) 41 is arranged for heating the ink ribbon 45 to sublimate the dye contained in the ribbon 45 and allow the dye to permeate into the printing medium P, thereby developing color on the printing medium P. The TPH 41 includes a plurality of heat emitting elements (not shown) arranged in the width direction of the printing medium P. The heat emitting elements selectively emit heat to develop color on the printing medium P as described above. The ink ribbon 45 is supported by being wounded on a pair of ribbon support wheels 46 and 47 so as to maintain the tension of the ink ribbon 45. A platen roller 43 is provided below the TPH 41 to press the printing medium P and the ink ribbon 45 toward the heat emitting elements (not shown) of the TPH 41.

In addition, a pair of delivery rollers 50 are arranged at the end of the paper feed slot 13 to face each other and to feed the printing medium P, which is inserted into the inside of the case 12 through the paper-feeding slot 13, between the TPH 41 and the platen roller 43, and repeatedly reciprocate the printing medium P between the TPH 41 and the platen roller 43 so that a color image may be formed on the printing medium P. One of the delivery rollers 50 is a driving roller, while the other is an idle roller driven by the rotation of the driving roller. A discharge slot 14 is provided in the lower side of the case 12 to output a printing medium P on which an image has been printed.

A printing process of the printing unit 40 will now be described below. The printing medium P inserted into the inside of the case 12 through the paper-feeding slot 13 is fed, by the delivery rollers 50, between the TPH 41 and the platen roller 43 spaced apart from each other. With the rear portion of the printing medium P seized by the delivery rollers 50, the delivery rollers 50 stop rotation, and the TPH 41 sticks closely to the platen roller 43 with the ink ribbon 45 and the printing medium P interposed between the TPH 41 and the platen roller 43.

To develop color, the delivery rollers 50 rotate in a direction opposite to a paper-feeding direction, and the printing medium P interposed between the TPH 41 and the platen roller 43 is picked by the delivery rollers 50 at the paper feeding slot 13, and moved to the direction opposite to the paper-feeding direction. The ink ribbon 45 travels with the same speed as the delivery speed of the printing medium P and the heat emitting elements (not shown) of the TPH 41 selectively emit heat to sublimate the dye contained in the ink ribbon 45 and develop color on the printing medium P, thereby forming an image on the printing medium P.

The ink ribbon 45 includes yellow Y, cyan C, magenta M sections, and a glossy section to realize a color image. While the printing medium P is repeatedly reciprocated between the TPH 41 and the platen roller 43 by the delivery rollers 50, each of the sections goes through a color developing process at least one time, so that a color image is printed on the printing medium P. The printing medium P on which a color image is printed is delivered to the paper-feeding direction by the delivery rollers 50 and discharged to the outside of the case 12 through the discharge slot 14. In another embodiment of the present invention, the printing medium P on which the color image is printed may be discharged to the outside of the case 12 through the paper-feeding slot 13.

Turning now to FIGS. 5 and 6, operations of a power switch 20 and a lens protection cap 25 as shown in FIG. 1 are shown. Referring to FIG. 5, a power switch 20 is located on the upper surface of the case 12, and includes a sliding lever 21 mounted on the case 12 and a metal power joint 22 attached underneath the sliding lever 21. A pair of terminals 28a and 28b adjacent to the power switch 20 are spaced from each other so that a power circuit 28 of the camera 10 (refer to FIG. 1) is opened. At this point, the power switch 20 is located at a power-off point and the lens protection cap 25 connected to the power switch 20 shields the lens 16 so that the lens 16 may not be exposed to the front side of the case 12 (refer to FIG. 1). Therefore, the lens 16 is protected from damage.

When a user pushes the sliding lever 21 of the power switch 20 to a side direction, i.e., to the left with his finger, the power switch 20 slides to a power-on point as shown in FIG. 6. At this point, the power switch 20 overlaps the pair of terminals 28a and 28b and the metal power joint 22 attached on the inside of the sliding lever 21 contacts both the terminals 28a and 28b, so that the power circuit 28 is connected and a current may flow through the power circuit 28. At this point, the lens protection cap 25 moves to the left as much as a distance the power switch 20 moves, to expose the lens 16 to the front side of the case 12. Therefore, a user may photograph an image using the camera 10.

When intending to turn off the camera 10, a user pushes the sliding lever 21 to the right at this time to slide the power switch 20 to the power-off point as shown in FIG. 5. At this point, the lens protection cap 25 shields the lens 16 again to protect the lens 15 from being damaged.

The camera according to the present invention includes the lens protection cap that cooperates with the on/off operations of the power switch to prevent the damage of the lens when the camera is not used. In addition, since the lens protection cap may realize exposing/shielding operations of the lens without a separate driving element such as a motor and a gear, the present invention is advantageous in miniaturizing a camera and reducing manufacturing costs. Also, since the present invention has a simple structure, possibility of camera disorder reduces. Moreover, since the printing unit 40 is incorporated into the camera 10, the space inside the camera 10 will be premium, and, as result, the use of a power switch 20 to remove a lens protection cap 25 is most advantageous. Further, the lens protection cap 25 can be configured to expose/shield the lens 16, either on the outer surface of the case 12 or an inner surface of the case 12 for the manufacturer's convenience.

While there have been illustrated and described what are considered to be example embodiments of the present invention, it will be understood by those skilled in the art and as technology develops that various changes and modifications may be made and equivalents may be substituted for elements thereof without departing from the true scope of the present invention. Many modifications, permutations, additions and sub-combinations may be made to adapt the teachings of the present invention to a particular situation without departing from the scope thereof. For example, the printing unit included in the camera may print an image in an inkjet or electro-photographic manner. In addition, the components and methods as show in FIG. 4, FIG. 5 and FIG. 6. can be implemented differently as long as their respective operations remain faithful to simple structure of opening/closing a lens without using driving elements, such as a motor and a gear. Accordingly, it is intended, therefore, that the present invention not be limited to the various example embodiments disclosed, but that the present invention includes all embodiments failing within the scope of the appended claims.

1. A camera comprising:
a case;
a lens located inside the case and exposed toward a front side;
a power switch provided on an outer surface of the case, for turning power ON/OFF; and
a lens protection cap arranged to prevent damage of the lens by shielding the lens when the power is turned OFF,
wherein the power switch and the lens protection cap are directly connected with each other such that the lens protection cap exposes/shields the lens when the power switch is turned ON/OFF.

2. The camera as claimed in claim 1, wherein the power switch slides in a side direction on the outer surface of the case to turn the power ON/OFF, and the lens protection cap moves in the side direction a distance the power switch slides, so as to expose the lens.

3. The camera as claimed in claim 2, wherein the power switch comprises a sliding lever mounted in the case such that the sliding lever is pushed in the side direction by a user's finger, and a metal power joint attached on the inside of the sliding lever, and
when the sliding lever is slid to one side, the metal power joint allows a power circuit of the camera to be connected so that a current flows through the power circuit to turn the power ON, while removing the lens protection cap from the lens.

4. The camera as claimed in claim 3, wherein the sliding lever of the power switch and the lens protection cap are connected with each other using a connector, and the sliding lever, the connector, and the lens protection cap are integrally formed.

5. The camera as claimed in claim 1, further comprising a printing unit arranged inside the case to print an image on a printing medium.

6. The camera as claimed in claim 5, wherein the printing unit comprises an ink ribbon containing dye that develops color on the printing medium, and a TPH (thermal print head) heating the ink ribbon to sublimate the dye contained in the ink ribbon, thereby allowing the dye to permeate into the printing medium.

7. The camera as claimed in claim 5, wherein the case comprises a paper-feeding slot for supplying a printing medium on which an image is to be printed to the inside of the case, and a discharge slot discharging a printing medium on which an image has been printed to the outside of the case.

8. A camera comprising:
a case;
a lens provided inside the case and exposed toward a front side of the case;
a power switch provided on at a designated location on the case to enable a user to turn power ON/OFF; and
a lens protection cap provided to protect the lens,
wherein the power switch and the lens protection cap are connected, via a connector, such that, when the power switch is turned ON, the lens protection cap uncovers the lens, and when the power switch is turned OFF, the lens protection cap covers the lens.

9. The camera as claimed in claim 8, wherein the power switch is mounted on an upper surface of the case, and is slidable in a side direction to turn the power ON/OFF, and the lens protection cap moves in the same side direction so as to cover/uncover the lens.

10. The camera as claimed in claim 8, wherein the power switch comprises a sliding lever mounted on the case, and a metal power joint attached on the inside of the sliding lever, such that, when the sliding lever is slid to one side, the metal power joint allows a power circuit of the camera to be connected so that a current flows through the power circuit to turn the power ON, while removing the lens protection cap from the lens.

11. The camera as claimed in claim 10, wherein the sliding lever, the connector, and the lens protection cap are integrally formed by a polymer resin.

12. The camera as claimed in claim 8, further comprising a printing unit arranged inside the case to print an image captured by the lens on a printing medium.

13. The camera as claimed in claim 12, wherein the printing unit comprises an ink ribbon containing dye that develops color on the printing medium, and a thermal print head for heating the ink ribbon to sublimate the dye contained in the ink ribbon, thereby allowing the dye to permeate into the printing medium.

14. The camera as claimed in claim 12, wherein the case comprises a paper-feeding slot for feeding the printing medium on which an image captured by the lens is to be printed into the inside of the case, and a discharge slot for discharging the printing medium on which an image has been printed to the outside of the case.

15. A camera comprising:
a rectangular parallelepiped case having a lens provided on a front side, a display panel provided on a back side, and a power switch provided on an upper surface of the case to turn power ON/OFF;
a printing unit arranged inside the case to print an image captured by the lens on a printing medium fed, via a paper feeding slot located on the upper surface of the case;
a lens protection cap provided to cover the lens,
wherein the power switch and the lens protection cap are connected, via a connector, such that, when the power switch is turned ON, the lens protection cap uncovers the lens, and when the power switch is turned OFF, the lens protection cap covers the lens.

16. The camera as claimed in claim 15, wherein the power switch is mounted on the upper surface of the case, and is slidable in a side direction to turn the power ON/OFF, and the lens protection cap moves in the same side direction so as to cover/uncover the lens.

17. The camera as claimed in claim 15, wherein the power switch comprises a sliding lever mounted on the case, and a metal power joint attached on the inside of the sliding lever, such that, when the sliding lever is slid to one side, the metal power joint allows a power circuit of the camera to be connected so that a current flows through the power circuit to turn the power ON, while removing the lens protection cap from the lens.

18. The camera as claimed in claim 15, wherein the sliding lever, the connector, and the lens protection cap are integrally formed by a polymer resin.

19. The camera as claimed in claim 15, wherein the printing unit comprises an ink ribbon containing dye that develops color on the printing medium, and a thermal print head for heating the ink ribbon to sublimate the dye contained in the ink ribbon, thereby allowing the dye to permeate into the printing medium.

20. The camera as claimed in claim 15, wherein the case comprises a paper-feeding slot for feeding the printing medium on which an image captured by the lens is to be printed into the inside of the case, and a discharge slot for discharging the printing medium on which an image has been printed to the outside of the case.

21. A camera comprising:
a case having a lens provided on a front side, a display panel provided on a back side, and a power switch provided on the case; and
a lens protection cap provided to cover the lens,
wherein the power switch and the lens protection cap are connected, via a connector, such that, when the power switch is turned ON, the lens protection cap is removed from the lens.

22. The camera as claimed in claim 21, wherein the power switch comprises a sliding lever mounted on an upper surface of the case, and a metal power joint attached on the inside of the sliding lever, such that, when the sliding lever is slid to one side, the metal power joint allows a power circuit of the camera to be connected so that a current flows through the power circuit to turn the power ON, while removing the lens protection cap from the lens.

23. The camera as claimed in claim 22, wherein the sliding lever, the connector, and the lens protection cap are integrally formed by a polymer resin.

24. The camera as claimed in claim 21, wherein the case comprises a paper-feeding slot for feeding the printing medium on which an image captured by the lens is to be printed into the inside of the case, and a discharge slot for discharging the printing medium on which an image has been printed to the outside of the case; and a printing unit is further provided inside the case to print an image captured by the lens on a printable medium fed, via the paper feeding slot.
